(19) United States
(12) Patent Application Publication
(10) Pub. No.: US 2013/0083556 A1
(43) Pub. Date: Apr. 4, 2013

(54) COMPUTER BEZEL WITH LIGHT-GUIDE STRUCTURE

(71) Applicant: Fu-Kuo Huang, New Taipei (TW)

(72) Inventor: Fu-Kuo Huang, New Taipei (TW)

(73) Assignee: HON HAI PRECISION INDUSTRY CO., LTD., New Taipei (TW)

(21) Appl. No.: 13/477,967

(22) Filed: May 22, 2012

(30) Foreign Application Priority Data
Sep. 30, 2011 (TW) 100135426

(51) Int. Cl. F21V 8/00

(52) U.S. Cl. 362/602

(57) ABSTRACT

A computer bezel includes a bezel body, a light source, a light-guide structure, and a button element. The bezel body defines a mounting opening. The light-guide structure includes a guiding portion and a lighting portion. The lighting portion includes a circular lighting body with a receiving opening. The circular lighting body is located in the mounting opening. The guiding portion includes a bottom surface and an inclined surface. An acute angle is defined between the bottom surface and the inclined surface. The inclined surface is connected to the circular lighting body via a first guiding surface. The button element includes a button body located in the receiving opening. When the button body is pressed, the guiding portion receives a plurality of light beams emitted from the light source via the bottom surface and guides the light beams to the circular lighting body of the lighting portion.

### BACKGROUND

1. Technical Field

The present disclosure relates to electronic devices, and more particularly to a computer bezel with a light-guide structure.

2. Description of Related Art

Indicator lamps are used in electronic devices such as computers and testing devices. The electronic device may include a panel, a circuit board, and an indicator lamp secured to an outside surface of the panel. A light source is electronically connected to the circuit board. The indicator lamp and the light source may be arranged in a straight line, that is substantially perpendicular to the circuit board, and light beams from the light source can be directly transmitted to the indicator lens. However, when the indicator lamp is attached to a different location, the light beams from the light source cannot be completely or efficiently transmitted to the indicator lamp. Thus, a brightness of the indicator lamp is so weak such that the indicator lamp may be nearly invisible. Therefore, an electronic device with an improved light-guide structure is desirable.

### BRIEF DESCRIPTION OF THE DRAWINGS

Many aspects of the embodiments can be better understood with reference to the drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a computer bezel in accordance with one embodiment.

FIG. 2 is similar to FIG. 1, but viewed from another aspect.

FIG. 3 is an assembled view of the computer bezel of FIG. 2.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

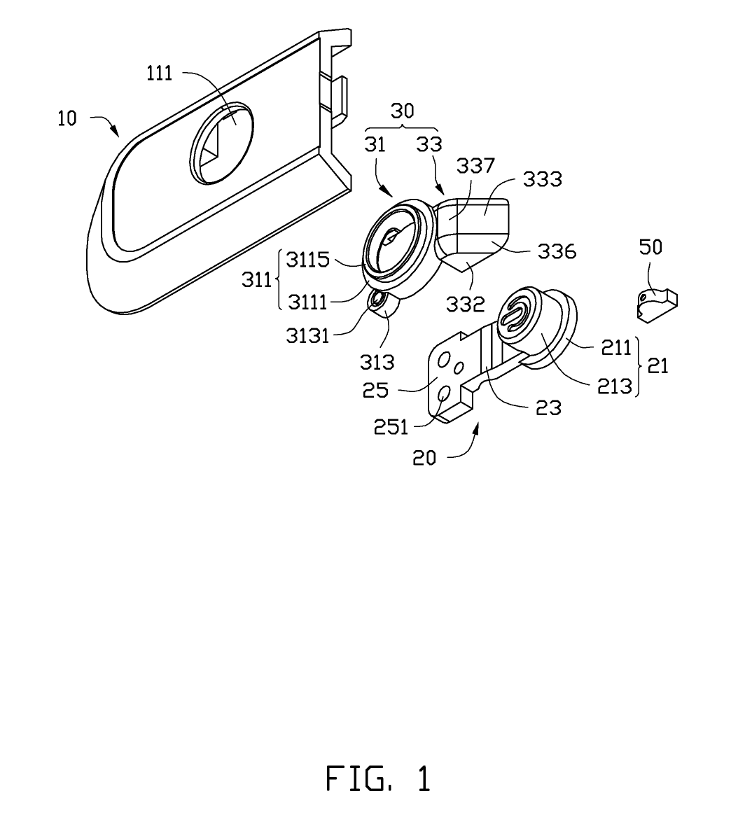

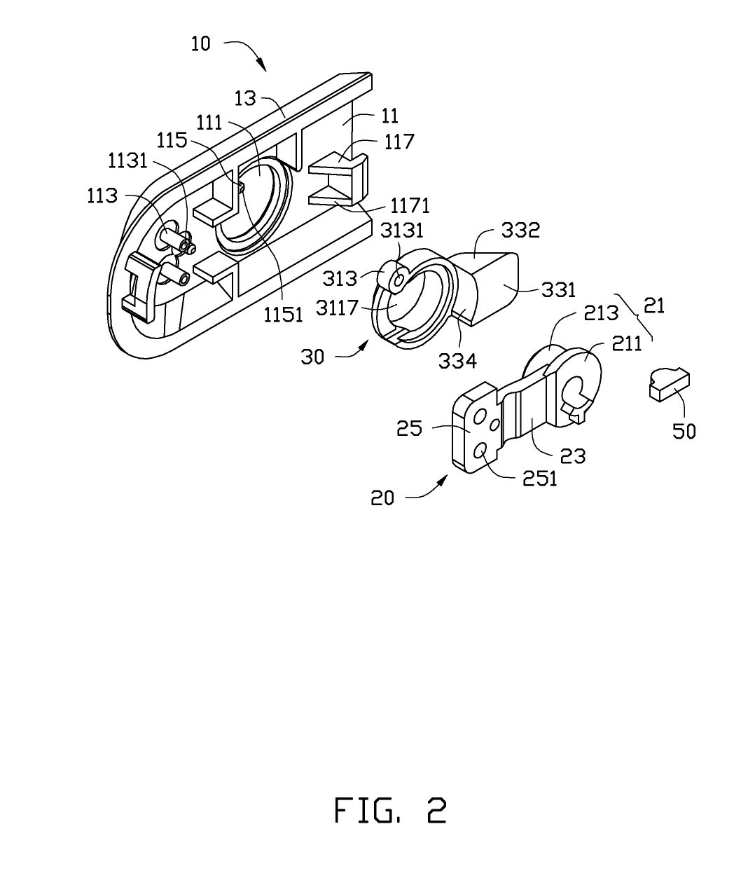

Referring to FIGS. 1 and 2, a computer bezel in accordance with an exemplary embodiment includes a bezel body 10, a button element 20, a light-guide structure 30, and a light source 50. In one embodiment, the light source 50 is a light emitting diode (LED), and is mounted on a printed circuit board (not shown).

The bezel body 10 includes a front panel 11 and two side panels 13 extending from the front pane 11. The front panel 11 defines a mounting opening 111. The mounting opening 111 is circular. The bezel body 10 includes three mounting posts 113 extending from the inner surface of the front panel 11. Each mounting post 113 defines a mounting hole 1131. The bezel body 10 further includes a positioning post 115. The positioning post 115 defines a positioning hole 1151. The bezel body 10 further includes a support portion 117 extending from the front panel 11. The support portion 117 defines a support surface 1171. An obtuse angle is defined between the support surface 1171 and the front panel 11.

The button element 20 includes a button portion 21, a connecting arm 23 extending from the button portion 21, and a mounting portion 25 extending from the connecting arm 23. The mounting portion 25 defines three through holes 251 corresponding to the mounting posts 113. The button portion 21 includes a base 211 extending from the connecting arm 23 and a button body 213 extending from the base 211.

The light-guide structure 30 includes a circular lighting portion 31 and a guiding portion 33 extending from the lighting portion 31. The guiding portion 33 includes a bottom surface 331 corresponding to the light source 50, two side surfaces 332 connected to the bottom surface 331, and an inclined surface 333 connected to the bottom surface 331. The bottom surface 331 is substantially parallel to the front panel 11. The two side surfaces 332 are substantially parallel to each other and substantially perpendicular to the bottom surface 331. An acute angle is defined between the inclined surface 333 and the bottom surface 331. The guiding portion 33 further includes an arc surface 334. The arc surface 334 is connected to the bottom surface 331 and the two side surfaces 332. The inclined surface 333 is connected to the lighting portion 31 via a first guiding surface 337. Each side surface 332 is connected to the inclined surface 333 via a second guiding surface 336. The second guiding surface 336 and the first guiding surface 337 are both arc-shaped.

The lighting portion 31 includes a circular lighting body 311 and a securing portion 313 extending from the lighting body 311. The lighting body 311 is substantially parallel to the front panel 11. The securing portion 313 defines a securing hole 3131. The lighting body 311 includes a outer circular portion 3111 and an inner circular portion 3115 extending from the outer circular portion 3111. The outer circular portion 3111 and the inner circular portion 3115 have the same central axis. The outer radius of the outer circular portion 3111 is greater than the outer radius of the inner circular portion 3115. The inner radius of the outer circular portion 3111 is substantially equal to the inner radius of the inner circular portion 3115. The radius of the mounting opening 111 is greater than the outer radius of the inner circular portion 3115 and shorter than the outer radius of the outer circular portion 3111. The inner circular portion 3115 defines a receiving opening 3117.

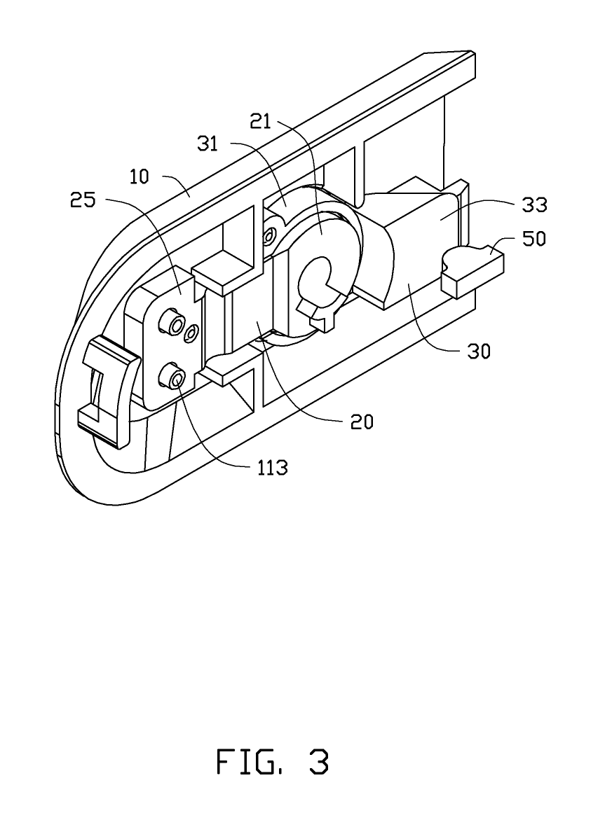

Referring to FIG. 3, in assembly, the inner circular portion 3115, of the light-guide structure 30, passes through the mounting opening 111 of the bezel body 10, to enable the outer circular portion 3111 to contact the inner surface of the front panel 11. The positioning post 115 is received in the securing hole 3131 of the light-guide structure 30. A fastener (not shown) is screwed into the positioning hole 1151 of the positioning post 115 to secure the light-guide structure 30 to the front panel 11. At this time, the inclined surface 333 of the light-guide structure 30 contacts the support surface 1171 of the bezel body 10. The button body 213 of the button element 20 passes though the receiving opening 3117 of the light-guide structure 30 to be exposed out of the bezel body 10. At this time, the mounting posts 113 of the bezel body 10 are received in the through holes 251 of the button element 20. Three screws (not shown) are screwed into the mounting holes 1131 of the mounting posts 113 to secure the button element 20 to the bezel body 10. The light source 50 is mounted on the bottom surface 331 of the light-guide structure 30.

In use, the light source 50 switches on when the button body 213 of the button element 20 is pressed. A plurality of light beams are emitted from the light source 50 into the inner circular portion 3115 of the lighting portion 31 via the guiding portion 33. The light beams are refracted from the inner circular portion 3115 so as to be externally visible to a user.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A computer bezel comprising:
a bezel body defining a mounting opening;
a light source mounted on the bezel body;
a light-guide structure mounted to the bezel body, the light-guide structure comprising a guiding portion and a lighting portion extending from the guiding portion; the lighting portion comprising a circular lighting body; the circular lighting body defining a receiving opening; the circular lighting body is located in the mounting opening and extends out of the bezel body; the guiding portion comprising a bottom surface, corresponding to the light source and substantially parallel to the circular lighting body, and an inclined surface, connected to the bottom surface, and an acute angle defined between the bottom surface and the inclined surface; and the inclined surface connected to the circular lighting body via a first guiding surface;
a button element, the button element comprising a button body, the button body located in the receiving opening to be exposed out of the bezel body;
wherein the guiding portion receives a plurality of light beams emitted from the light source via the bottom surface and guides the plurality of light beams to the circular lighting body of the lighting portion.

2. The computer bezel of claim 1, wherein the circular lighting body comprises a outer circular portion and a inner circular portion extending from the outer circular portion, and the outer circular portion and the inner circular portion have a same axis; a first outer radius of the outer circular portion is greater than a second outer radius of the inner circular portion; the receiving opening is defined in the inner circular portion; the inner circular portion is located in the mounting opening and extends out of the bezel body; and the outer circular portion is located on an inner surface of the bezel body.

3. The computer bezel of claim 2, wherein a first inner radius of the outer circular portion is substantially equal to a second inner radius of the inner circular portion.

4. The computer bezel of claim 1, wherein the first guiding surface comprises an arc-shaped portion.

5. The computer bezel of claim 1, wherein the guiding portion further comprises two side surfaces connected to the bottom surface; the two side surfaces are perpendicular to the bottom surface; and each side surface is connected to the inclined surface via an arc-shaped second guiding surface.

6. The computer bezel of claim 5, wherein the guiding portion further comprises an arc surface connected to the bottom surface and the two side surfaces.

7. The computer bezel of claim 1, wherein the bezel body comprises a front panel; the mounting opening is defined in the front panel; and the bottom surface is substantially parallel to the front panel.

8. The computer bezel of claim 1, wherein the guiding portion further comprises a securing portion extending from the lighting portion; the securing portion defines a securing hole; and the bezel body comprises a positioning post received in the securing hole.

9. The computer bezel of claim 1, wherein the button element further comprises a connecting arm, extending from the button body, and a mounting portion, extending from the connecting arm; the mounting portion defines a through hole; and the bezel body comprises a mounting post received in the through hole.

10. A computer bezel comprising:
a bezel body comprising a front panel, the front panel defining a mounting opening;
a light source mounted on the bezel body;
a light-guide structure mounted to the bezel body, the light-guide structure comprising a guiding portion and a lighting portion extending from the guiding portion; the lighting portion defining a receiving opening; the lighting portion located in the mounting opening and extending out of the bezel body; the guiding portion comprising a bottom surface, corresponding to the light source, and an inclined surface, connected to the bottom surface, and an acute angle defined between the bottom surface and the inclined surface; the inclined surface connected to the lighting portion via a first guiding surface; and the bottom surface substantially parallel to the front panel;
a button element, the button element comprising a button body, the button body located in the receiving opening and extending out of the bezel body, the light-guide structure located between the button element and the front panel;
wherein the guiding portion receives a plurality of light beams emitted from the light source via the bottom surface and guides the plurality of light beams to the lighting portion.

11. The computer bezel of claim 10, wherein the lighting portion comprises a outer circular portion and a inner circular portion extending from the outer circular portion, the outer circular portion and the inner circular portion have a same axis; a first outer radius of the outer circular portion is greater than a second outer radius of the inner circular portion; the receiving opening is defined in the inner circular portion; the inner circular portion is located in the mounting opening to be exposed out of the bezel body; and the outer circular portion is located on an inner surface of the bezel body.

12. The computer bezel of claim 11, wherein a first inner radius of the outer circular portion is substantially equal to a second inner radius of the inner circular portion.

13. The computer bezel of claim 10, wherein the first guiding surface comprises an arc-shaped portion.

14. The computer bezel of claim 10, wherein the guiding portion further comprises two side surfaces connected to the bottom surface; the two side surfaces are perpendicular to the bottom surface; each side surface is connected to the inclined surface via an arc-shaped second guiding surface.

15. The computer bezel of claim 14, wherein the guiding portion further comprises an arc surface connected to the bottom surface and the two side surfaces.

16. The computer bezel of claim 10, wherein the guiding portion further comprises a securing portion extending from the lighting portion; the securing portion defines a securing hole; and the bezel body comprises a positioning post received in the securing hole.

17. The computer bezel of claim 10, wherein the button element further comprises a connecting arm extending from the button body and a mounting portion extending from the connecting arm; the mounting portion defines a through hole; and the bezel body comprises a mounting post received in the through hole.
